(19) United States
(12) Patent Application Publication
(10) Pub. No.: US 2004/0113910 A1
(43) Pub. Date: Jun. 17, 2004

(54) System and method for the rebuild of curve networks in curve-based surface generation using constrained-surface fitting

(75) Inventors: Yi-Feng Tsai, Ann Arbor, MI (US); Thawach Sripradisvarakul, Ann Arbor, MI (US)

Correspondence Address: DOCKET CLERK, DM/EDS, P.O. DRAWER 800889, DALLAS, TX, 75380, US

(73) Assignee: ELECTRONIC DATA SYSTEMS CORPORATION, Plano, TX

(21) Appl. No.: 10/318,344

(22) Filed: Dec. 12, 2002

(51) Int. Cl. G06T 17/00

(52) U.S. Cl. 345/420

(57) ABSTRACT

A system and method for simultaneously rebuilding a network of curves so that the resulting curves have certain desirable qualities for subsequent surface generation. The method employs an iterative surface fitting routine that approximates sampled points of the curves, subject to constraints that are compatible with the global satisfactions of surface quality requirements such as smoothness, boundary continuity or surface cleanness and simplicity. Corresponding iso-parametric curves of the surface thus found can then be extracted as the output curves. This method can be used in any curve-based surface generation scheme as a pre-processor, to ensure that the input curves are suitable for creating surfaces with desirable geometric/aesthetic qualities.

### TECHNICAL FIELD OF THE INVENTION

The present application relates to improved graphics processing techniques, and in particular to improved surface generation in 3-dimensional graphics objects. Still more particularly, this application relates to class-A surface generation for computer-aided design with free-form surface modeling.

### BACKGROUND OF THE INVENTION

Curve-based surface generation schemes are very commonly used in computer-aided geometric design (CAGD) for modeling of free-form geometry. One of the simplest among them is skinning, which interpolates a series of curves to form a surface. Also known as lofting, this method stretches a surface over a series of “ribs” or cross-sections. The surface will preserve the shape of each cross-section at the corresponding location, and will blend smoothly from one to the next. FIG. 1A illustrates the skinning technique; note the “ribs”, or cross-sections, shown on the left; these are used as a basis for the generated “skin” surface shown on the right.

More complicated methods interpolating a network of curves, as shown in FIG. 1B and FIG. 1C, are also well-developed, and readily available in modern geometric modeling systems. These methods provide very intuitive and powerful surface generation tools for designers, since the output surface exactly follows the “idea” implied by the input curves, and it is generally much easier to create curves than surfaces from scratch. In FIGS. 1B and 1C, the basic curve network shown on the left is interpolated to form the surface on the right.

In a general sense, “continuity” describes how two things come together. Two types of continuity are generally discussed: Cⁿ and Gⁿ, where n refers to the order of continuity. Cⁿ continuity refers to “parametric” continuity of the n^{th} order. This means that the magnitude and direction of all derivatives up to the n^{th} order must agree. Gⁿ continuity, on the other hand, refers to “geometric” continuity of the n^{th} order, which loosens the above definition by allowing re-parametrizations from the Cⁿ condition. A good example is the 1^{st} order continuity: C¹ between two curves requires the two end tangent vectors to be identical, while the G¹ condition only requires the two end tangent vectors to be in-line. Although not as strict as parametric continuity, geometric continuity is more useful in CAGD in that it describes the sufficient conditions for two connecting entities to “look” smooth in the neighborhood of their juncture.

Class-A (or sometimes referred to as class-1) geometric design typically sets stringent standards in surface quality in order to satisfy aesthetic or aerodynamic goals. In most cases, class-A surfaces are required to be curvature continuous while providing the simplest mathematical representation needed for the desired shape/form, and does not have any undesirable waviness.

Free-form surface modeling of a car body, for instance, requires the generated surface patches to maintain good continuity (up to G²) with each other, as well as to demonstrate visual smoothness everywhere when observed in lights. In addition, there are always requirements that the surfaces should be “simple” and “clean,” that is, having a reasonable number of control points, a good structure of the control net, and nice parametric flows. Heavier than necessary surface geometry may pose problems to subsequent processes, such as further geometry generation based on the existing ones, mesh generation and NC tool path generation. Unclean or “messy” control net structure is undesirable for designers, who rely heavily on control point editing to modify geometric entities. All of the above quality can be examined using various diagnostic tools in modern geometric modeling systems. Some of these are demonstrated in FIG. 2.

FIGS. 2A-2D show various surface quality diagnostic tools applied on a model that comprises six surfaces. FIG. 2A shows a continuity needles plot, which displays the discontinuity measurement between surfaces by needles (vectors) of various lengths and directions. FIG. 2B shows a surface contours plot, where each contour represents constant reflectance of light on the surfaces. The smoothness of the contours reflects the smoothness of the surfaces. FIG. 2C shows a curvature needles plot, which displays the distribution of cross-sectional curvatures on the surfaces. This plot illustrates the curvature “flow” on the surfaces, and is a good indicator for different types of shape imperfections. FIG. 2D shows a zebra plot, which imitates the shape inspection environment in the automotive body design process where the model is inspected in a room with arrays of lights. Similar to the contours plot, it provides a clear visualization of the smoothness of the surfaces.

Clearly, the quality of curve-based surface generation largely depends on the quality of the input network of curves. It is impossible, for example, to create a surface that is G¹ continuous to its neighboring surfaces by interpolating curves that fail to achieve boundary G¹ continuity. In reality, however, much design efforts and experience are necessary to construct “optimal” networks of curves that satisfy all of the given requirements. Editing the curves to satisfy one requirement often leads to the violation of another, thus making the design process very arduous and time-consuming. As can be expected, this difficulty only exacerbates when more and more geometric entities are built in relation to each other. The construction of the model in FIG. 2, for example, involves the generation of six surfaces adjacent to each other, starting with six networks of curves. Any local change in the composite networks of curves may entail a global effect, and hence influence some of the quality diagnostics once the surfaces are built. It is clearly a complicated and difficult task to create “good enough” input curves that yield surfaces with desirable quality.

A function that automatically rebuilds these imperfect networks of curves subject to given constraints is thus desirable, to ensure the required quality of the output surface. Rebuilding a curve typically requires fitting to sampled data of the curve to a prescribed tolerance, subject to given constraints.

Standard techniques exist for solving the curve-fitting problem. Simply rebuilding the input curves independently, however, may not entail a suitable network of curves for high quality surface generation. Individually satisfactory curves may represent only local or partial fulfillment of the desirable surface quality, and hence may not always produce output surfaces that meet all of the requirements. FIG. 3 illustrates some of these pathological cases, wherein curves that satisfy local or partial quality requirements produce globally unsatisfactory results, as described more fully below.

It would therefore be desirable to provide a curve rebuild system and method that is capable of satisfying all of the surface quality requirements simultaneously.

### SUMMARY OF THE INVENTION

To address the above-discussed deficiencies of the prior art, it is a primary object of the present invention to provide improved graphics processing techniques. It is another object of the present invention to provide an improved system and method for surface generation in 3-dimensional graphics objects.

The foregoing objects are achieved as is now described. The preferred embodiment provides a system and method for simultaneously rebuilding a network of curves so that the resulting curves have certain desirable qualities for subsequent surface generation. The method employs an iterative surface fitting routine that approximates sampled points of the curves, subject to constraints that are compatible with the global satisfactions of surface quality requirements such as smoothness, boundary continuity or surface cleanness and simplicity. Corresponding iso-parametric curves of the surface thus found can then be extracted as the output curves. This method can be used in any curve-based surface generation system as a pre-processor, to ensure that the input curves are suitable for creating surfaces with desirable geometric/aesthetic qualities.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of illustrative sample embodiments when read in conjunction with the accompanying drawings, wherein:

FIGS. 1A-1C depict common curve-based surface generation methods. FIG. 1A illustrates interpolating a series of curves to form a surface; FIG. 1B illustrates interpolating a 2 by N network of curves to form a surface; and FIG. 1C illustrates interpolating an M by N network of curves to form a surface.

FIGS. 2A-2D show various surface quality diagnostic tools. FIG. 2A shows a continuity needles plot; FIG. 2B shows a surface contours plot; FIG. 2C shows a curvature needles plot; and FIG. 2D shows a zebra plot.

FIG. 3 depicts examples of how curves satisfying local or partial quality requirements may produce globally unsatisfactory surfaces.

FIG. 4 is a schematic illustration of a global rebuild method using constrained-surface fitting in accordance with the preferred embodiment.

FIG. 5 is a flowchart of a global rebuild method using constrained-surface fitting in accordance with the preferred embodiment.

### DETAILED DESCRIPTION OF THE INVENTION

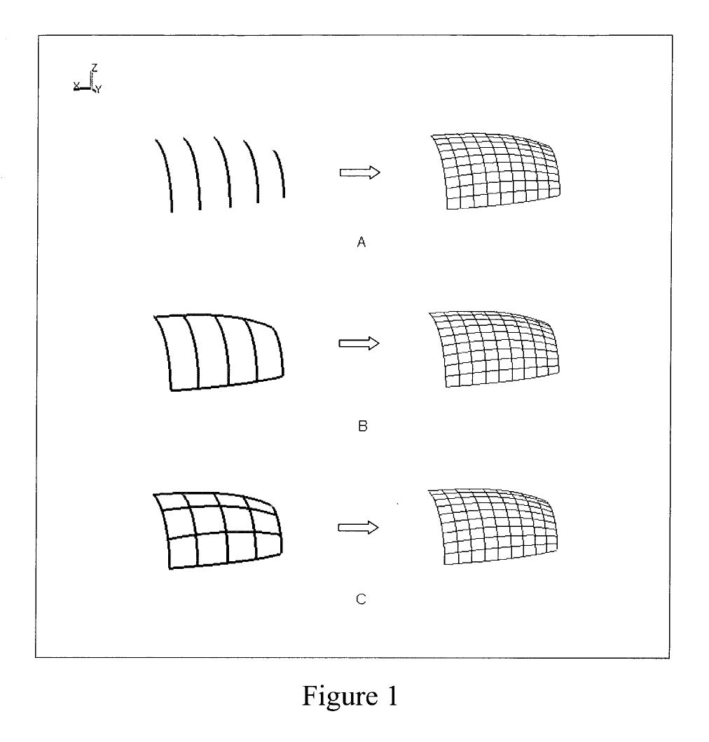

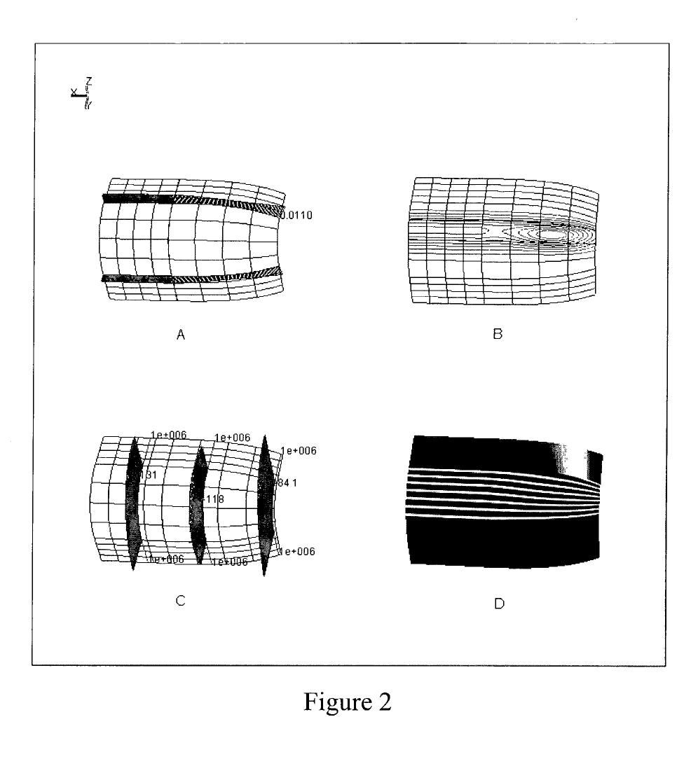

FIGS. 1 through 5, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

Definitions: Following are short definitions of the usual meanings of some of the technical terms which are used in the present application. (However, those of ordinary skill will recognize whether the context requires a different meaning.) Additional definitions can be found in the standard technical dictionaries and journals:

B-spline curve—A free-form, parametrically defined curve in which each vertex has an influence over a defined range of the curve.

B-spline surface—A free-form, parametrically defined surface in which each vertex has an influence over a defined range of the surface.

Iso-parametric curve—A B-spline curve obtained by tracing on a B-spline surface along the entire domain of one of the (u, v) parameters, with the value of the other parameter kept constant. Iso-parametric curves obtained by keeping the u parameter constant are referred to as “constant-u iso-parametric curves”. Similarly for “constant-v iso-parametric curves”.

Knots—A knot is a number which is part of the definition of a B-spline curve or surface and which is used to control its shape. The collection of all knots used by a B-spline is called a knot vector. The distance between knot values is called its knot spacing. Uniform B-splines set the knot spacing to 1 (usually), and non-uniform rational B-splines allow for uneven spacing of the knots.

Compatible in the B-spline sense—A set of B-spline curves are said to be compatible in the B-spline sense if they have the same degree and knot sequence.

The preferred system and method allows a global curve rebuild using constrained-surface fitting. The curves are sampled into data points, with the u, v parameters of each point properly assigned. A tensor-product B-spline surface (hereinafter referred to as the “intermediate” surface) is then fitted to this collection of point data subject to constraints. The fitting is performed iteratively with increasing surface knots, until a prescribed positional tolerance is met. Finally, iso-parametric curves corresponding to the original input curves are extracted from the surface to form the rebuilt curves.

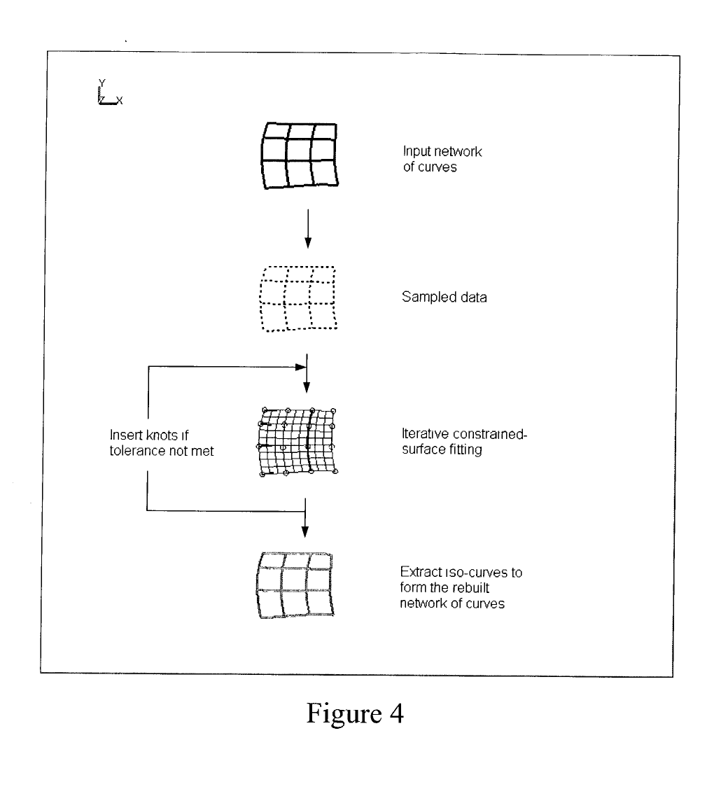

FIG. 4, described more fully below, shows a schematic illustration of a global rebuild using constrained-surface fitting, in accordance with a preferred embodiment. The advantage of this approach is apparent, in that it allows simultaneous rebuild of all of the curves, while realizing constraints on the curves that are compatible with the surface quality requirements.

Many different constraints can be imposed for the iterative surface fitting. For example, one can define G¹ and G² continuity constraints at the ends of the curves, as well as fixed-point constraints at the network grid points to ensure proper intersection of the curves. Fixed-iso-parametric curve constraints can be used to retain curves in the network that don't require rebuild. All of these constraints can be written as linear equations in terms of the surface control points. A standard linear system solver is then used to find the solution.

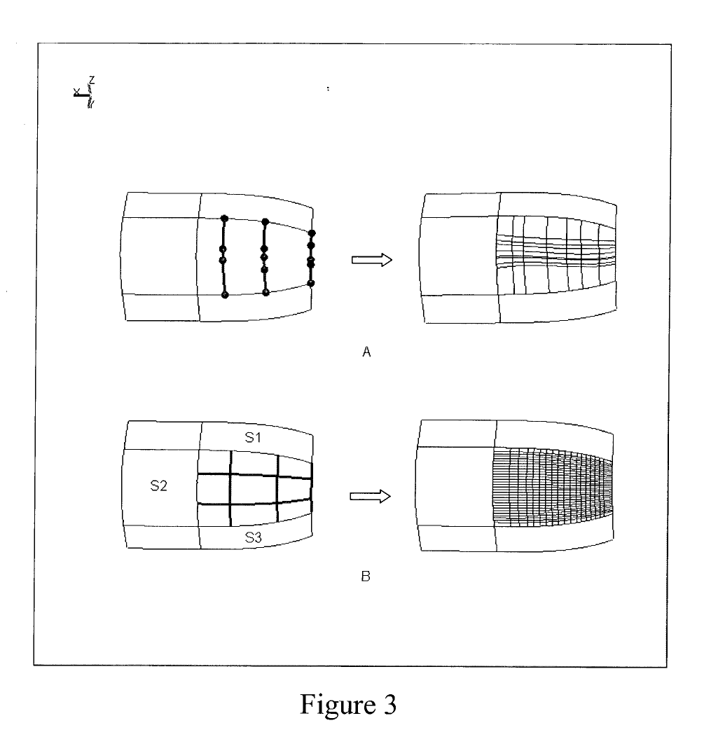

FIG. 3 shows examples of how curves satisfying local or partial quality requirements may produce globally unsatisfactory surfaces. In FIG. 3A, the curves are good in shape but very different in parameterizations, and hence produce a surface with bad parametric flow. In FIG. 3B, the vertical curves are made continuous to surfaces S1, S3, while the horizontal curves are made continuous to surface S2. However, in doing so, the curves are modified and no longer intersect each other. Very dense knots are thus needed in the subsequent surface generation in order to properly approximate the curves.

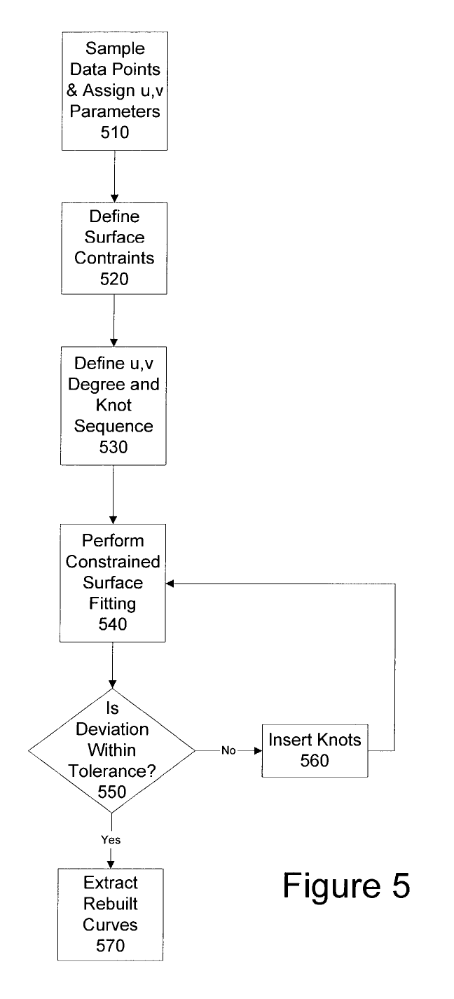

FIG. 4 is a schematic illustration of the global rebuild method using constrained-surface fitting. Sampled data of the input curves are fitted iteratively with a surface subject to constraints, with increasing knots, until the positional tolerance is met. Corresponding iso-parametric curves of the intermediate surface thus found then constitute the output curves. Note that the figure shows an example of having 3 different types of constraints in the surface fitting: fixed-iso-parametric curve constraints (denoted by the solid curve), fixed point constraints (denoted by circles) and boundary G¹ constraints (denoted by needles). A detailed description of the process is given below, with reference also to the flowchart depicted in FIG. 5:

First, take sampled data points from each curve in the input network. The sampling can be done based on the geometry of the curves, for example, one may sample based on equal arc length or local curvature variation. Assign u, v parameters to each data point using suitable methods (step 510).

Next, define desirable surface constraints (step 520). Typical constraints involve the following:

Fixed-point constraints;

Fixed-iso-parametric curve constraints;

G¹/G² constraints at the curve end points;

Other special constraints can also be defined, for example, fixed-surface control point constraints if some known surface control points are to be fixed; twist compatibility constraints when G¹/G² continuity are required simultaneously on adjacent boundaries of the surface, which might incur twist incompatibility problems, etc.

Next, define starting u, v degree and knot sequence for the intermediate surface (step 530).

Next, perform constrained-surface fitting to obtain a surface (step 540).

Check positional deviation from the produced surface to the point data (step 550). If the deviation is within the prescribed tolerance, go to step 570.

Insert knots according to suitable criteria (step 560) and return to step 540.

Then, extract iso-parametric curves from the intermediate surface at locations corresponding to the input network (step 570). The curves then form the desirable network.

The rebuilt network of curves obtained from the above procedure enjoys the following advantageous characteristics:

All of the rebuilt curves preserve the original shape (according to the tolerance).

All of the rebuilt curves, being extracted from the same surface, are compatible in the B-spline sense, and are therefore ready for direct application of subsequent operations.

All of the desirable quality constraints are built in to the rebuilt curves. Furthermore, these quality constraints are realized in the surface context. Subsequent operations are therefore guaranteed optimal input conditions, no matter what interpolation or fitting method is being used.

The proposed global rebuild method provides a powerful tool for automating the often tedious and complicated manual curve-editing process in class-A design. The designer can simply create networks of curves that convey the desirable shape. The rebuild function will then finds the optimal approximation to the networks, according to given tolerance and quality constraints. Undesirable properties inherited from the networks of curves will thus be mostly eliminated in the subsequent surface generation processes.

The role of the intermediate surface in this method deserves more subtle discussions. It may appear to be an “overkill” to create a surface in order to obtain a new network of curves for the final surface generation. However, since quality of the network of curves is crucial to quality of the subsequent curve-based surface generation, it is important to eliminate potential problems as much as possible, at the stage of rebuilding the curves. As discussed previously, the rebuilt network of curves will be suitable for generating a high quality surface if every part of the network conforms to the required surface quality conditions simultaneously. It is therefore necessary to solve the curve rebuild problem in the surface, or global, context. This in essence imitates (and automates) the manual curve-editing process in class-A design: whenever the designer modifies a part of the network, the resulted change in diagnostics of the entire network is inspected. Possible effects to the surface being generated are pictured (in mind). And if this modification causes side effects, further editing will be performed on other parts of the network with the same inspection procedures. This process repeats until the designer is convinced that the network of curves is “good enough” for the subsequent surface generation.

It should be noted that this intermediate surface generated cannot generally be used directly as the output surface of the curve-based surface generation. The goal of the intermediate surface is to produce a new network of curves with optimal conditions. It will therefore be close enough to the original curves (according to the positional tolerance), and conform to given constraints, at locations corresponding to the curves only (see FIG. 4). It will not, in general, enjoy the required quality conditions over the entire surface.

In alternative implementations of the method, the intermediate surface-fitting step can be simplified. The tensor-product form of the B-spline surface indicates the mutual independence of a constant-u iso-parametric curve and a constant-v iso-parametric curve, except in the local support of their intersection. This neighborhood, however, will certainly be fixed due to the requirement of proper connectivity at network grid points. Since the curves in the network are by definition iso-parametric curves of the surface, and the primary concerns in this method are positional accuracy and satisfaction of constraints on the curves only, there is no need to construct the full surface in the iterative fitting process. The same goals can be achieved by separating the constant-u and constant-v curves in the network. The two sets of curves can then be arranged in the simplest possible surface forms respectively. The global rebuild problem is thus decomposed into two smaller sub-problems that can be solved independently and in most cases more efficiently. The results can then be combined to form the output curves. One can think of this approach as modifying the intermediate surface-fitting step to have a “simultaneous curve-fitting flavor”.

The terms and conventional techniques used herein will be familiar to those of skill in the art of computer-aided geometric design. Further reference may be made to Celniker, G. et al., “Deformable curve and surface finite-elements for free-form shape design”, Computer Graphics, 25, 257-266, 1991; Celniker, G. et al., “Linear constraints for deformable B-spline surfaces”, Proceedings of the Symposium on Interactive 3D Graphics, 25(2), 165-170, 1992; Farin, G., Curves and Surfaces for Computer Aided Geometric Design, 4th Ed., Academic Press, 1997; Farin, G. et al., “Discrete Coons patches”, Computer Aided Geometric Design 16, 691-700, 1999; Hu, S.-M. et al., “Modifying the shape of NURBS surfaces with geometric constraints”, Computer Aided Design, 33, 903-912, 2001; Park, H. et al., “A method for approximate NURBS curve compatibility based on multiple curve refitting”, Computer Aided Design, 32, 237-252, 2000; Park, H. et al., “Smooth surface approximation to serial cross-sections”, Computer Aided Design, 28, 995-1005, 1996; Piegl, L. et al., “Least-squares B-spline curve approximation with arbitrary end derivatives”, Engineering with Computers, 16, 109-116, 2000; Piegl, L. et al., “Cross-sectional design with boundary constraints”, Engineering with Computers, 15, 171-180, 1999; and Weiss, V. et al., “Advanced surface fitting techniques”, Computer Aided Geometric Design, 19, 19-42, 2002, which are all hereby incorporated by reference.

It is important to note that while the preferred embodiment has been described in the context of a process and method, those skilled in the art will appreciate that at least portions of the preferred embodiments are capable of being distributed in the form of instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A method for rebuilding curves, comprising:
loading sample datapoints from a set of original curves;
defining surface constraints;
performing constrained-surface fitting to produce an intermediate surface; and
extracting iso-parametric curves from the intermediate surface.

2. The method of claim 1, further comprising, before the extracting step, p1 measuring the positional deviation of the surface at points corresponding to the sample datapoints, and
if the positional deviation is not within a predetermined tolerance, then inserting knots and repeating the performing step.

3. The method of claim 1, further comprising,
defining a starting u,v degree and knot sequence for the intermediate surface.

4. The method of claim 1, wherein the iso-parametric curves are b-spline compatible.

5. The method of claim 1, wherein the surface constraints include fixed-point constraints.

6. The method of claim 1, wherein the surface constraints include fixed iso-parametric curve contraints.

7. The method of claim 1, wherein the surface constraints include G¹/G² contraints at curve endpoints.

8. The method of claim 1, wherein the surface constraints include fixed-surface control point constraints.

9. The method of claim 1, wherein the iso-parametric curves are used to produce a class-A surface.

10. The method of claim 1, wherein the iso-parametric curves correspond to the set of original curves, within the surface constraints.

11. A computer program product tangibly embodied in a computer-readable medium, comprising:
instructions for loading sample datapoints from a set of original curves;
instructions for defining surface constraints;
instructions for performing constrained-surface fitting to produce an intermediate surface; and
instructions for extracting iso-parametric curves from the intermediate surface.

12. The computer program product of claim 11, further comprising,
instructions for measuring the positional deviation of the surface at points corresponding to the sample datapoints, and
instructions for inserting knots and repeating the performing instructions if the positional deviation is not within a predetermined tolerance.

13. The computer program product of claim 11, further comprising instructions for defining a starting u,v degree and knot sequence for the intermediate surface.

14. The computer program product of claim 11, wherein the iso-parametric curves are b-spline compatible.

15. The computer program product of claim 11, wherein the surface constraints include fixed-point constraints.

16. The computer program product of claim 11, wherein the surface constraints include fixed iso-parametric curve contraints.

17. The computer program product of claim 11, wherein the surface constraints include G¹/G² contraints at curve endpoints.

18. The computer program product of claim 11, wherein the surface constraints include fixed-surface control point constraints.

19. The computer program product of claim 11, wherein the iso-parametric curves are used to produce a class-A surface.

20. The computer program product of claim 11, wherein the iso-parametric curves correspond to the set of original curves, within the surface constraints.
